(19) United States
(12) Patent Application Publication
(10) Pub. No.: US 2015/0145400 A1
(43) Pub. Date: May 28, 2015

(54) REFRIGERATOR

(71) Applicant: SAMSUNG ELECTRONICS CO., LTD., Suwon-si (KR)

(72) Inventors: Jee Hoon LEE, Goyang-si (KR); Yong Soo Kyong, Seoul (KR); Jea Won Lee, Hwaseong-si (KR); Kyung Han Jeong, Suwon-si (KR)

(73) Assignee: SAMSUNG ELECTRONICS CO., LTD., Suwon-si (KR)

(21) Appl. No.: 14/552,934

(22) Filed: Nov. 25, 2014

(30) Foreign Application Priority Data
Nov. 27, 2013 (KR) 10-2013-0145018

(51) Int. Cl. F25D 23/02; F25D 11/00; A47B 71/00; E05D 7/10

(52) U.S. Cl. CPC F25D 23/028; E05D 7/10; F25D 11/00; A47B 71/00; F25D 2323/024
USPC 312/405; 16/254

(57) ABSTRACT

A refrigerator having an improved structure so as to easily assemble a detachable door and a main body. The refrigerator includes a main body that forms an appearance of the refrigerator, a storage chamber that is provided inside the main body, a door that is rotatably coupled to the main body to open and close an opened front surface of the storage chamber, and a hinge bracket that connects the main body and the door. Here, the hinge bracket may include a first hinge that is coupled to the main body and a second hinge that is coupled to the door and detachably coupled to a front side of the first hinge.

### CROSS-REFERENCE TO RELATED APPLICATIONS

This application claims the benefit of Korean Patent Application No. 10-2013-0145018, filed on Nov. 27, 2013 in the Korean Intellectual Property Office, the disclosure of which is incorporated herein by reference.

### BACKGROUND

1. Field

Embodiments of the present disclosure relate to a refrigerator, and more particularly, to a refrigerator having an improved structure so as to easily assemble a detachable door and a main body.

2. Description of the Related Art

In general, a refrigerator is an apparatus that keeps foods fresh while including a main body that forms an appearance, a storage chamber that is provided inside the main body so as to be opened at its front surface, and a cold air supply device that supplies cold air to the storage chamber.

The refrigerator keeps foods frozen or cold in accordance with a state of the food desired to be stored, and for this, cold air supplied into the refrigerator is generated by a heat exchange operation of a refrigerant.

That is, the cold air is continuously supplied into the refrigerator while a cycle of compression-condensation-expansion-evaporation is repeatedly performed, the supplied cold air is transmitted evenly into the refrigerator by convection, and therefore foods inside the refrigerator can be stored at a desirable temperature.

The opened front surface of the storage chamber of such a refrigerator is normally closed by a door in order to maintain the temperature of the storage chamber. The door is hinge-coupled to the main body, and mounted to be selectively rotatable.

When the door and the main body are required to be separated from each other in a process of installing the refrigerator, a hinge device installed in upper and lower portions of the refrigerator should be disassembled. In this instance, a bolt installed on a bottom surface of the main body for fixing the hinge device is required to be removed in order to disassemble the hinge device installed in the lower portion of the refrigerator, and therefore there is inconvenience in which the refrigerator should be laid.

### SUMMARY

Therefore, it is an aspect of the present disclosure to provide a refrigerator that has an improved structure so as to enhance installation convenience of the refrigerator by allowing a door and a main body to be separated from each other in a state in which the refrigerator is erected.

It is another aspect of the present disclosure to provide a refrigerator that has an improved structure so as to improve durability of a detachable hinge bracket.

Additional aspects of the disclosure will be set forth in part in the description which follows and, in part, will be obvious from the description, or may be learned by practice of the disclosure.

In accordance with one aspect of the present disclosure, a refrigerator includes: a main body that forms an appearance of the refrigerator; a storage chamber that is provided inside the main body; a door that is rotatably coupled to the main body to open and close an opened front surface of the storage chamber; and a hinge bracket that connects the main body and the door, wherein the hinge bracket includes a first hinge that is coupled to the main body and a second hinge that is coupled to the door and detachably coupled to a front side of the first hinge.

In this instance, at least one fastening hole corresponding to at least one connection member for connecting the first hinge and the second hinge may be formed on a front surface of the first hinge, so that the at least one connection member is coupled to the front surface of the first hinge.

Also, the at least one connection member may include a body that is coupled to the at least one fastening hole to face a rear side of the first hinge, and a head that extends from the body and protrudes from the at least one fastening hole to face a front side of the first hinge.

Also, at least one connection member through hole corresponding to the at least one connection member may be formed on one surface of the second hinge facing the at least one fastening hole, so that the second hinge is detachably coupled to the at least one connection member.

Also, the second hinge may be coupled to the at least one connection member so that the head passes through the at least one connection member through hole to face a front side of the second hinge.

Also, the at least one connection member through hole may include a fastening unit through which the head passes toward the front side of the second hinge, and a locking unit that is connected to the fastening unit to be coupled to the body to prevent the head from being separated from the at least one connection member through hole.

Also, the fastening unit may have a diameter larger than that of the head so that the head passes through the fastening unit, and the locking unit may have a diameter smaller than that of the fastening unit so that the locking unit is coupled to the body having a diameter smaller than that of the head.

Also, when the second hinge slides in a first direction in a state in which the head passes through the fastening unit, the head may be positioned in a front side of the locking unit, and one end portion of the body extending from the head may be coupled to the locking unit.

Also, when the second hinge slides in a second direction, the head may be positioned in a front side of the fastening unit so that the second hinge can be separated from the at least one connection member.

Also, a second fixing hole corresponding to a first fixing hole provided in the front side of the first hinge may be formed on one surface of the second hinge facing the at least one fastening hole, and the second hinge may be coupled to the front side of the first hinge by a fixing member passing through the second fixing hole and the first fixing hole toward the rear side of the first hinge, to thereby compensate a coupling force between the first hinge and the second hinge.

Also, the at least one connection member may be formed integrally with the first hinge so that the head protrudes from the at least one fastening hole.

Also, the first hinge may include at least one stopper that is provided in a rear side of the at least one fastening hole to support the at least one connection member passing through the at least one fastening hole.

In accordance with another aspect of the present disclosure, a refrigerator includes: a main body that forms an appearance of the refrigerator; a storage chamber that is provided inside the main body; a door that is rotatably coupled to the main body to open and close an opened front surface of the storage chamber; and a hinge bracket that connects the main body and the door, wherein the hinge bracket includes a first hinge that is coupled to a lower portion of the main body, a second hinge that is coupled to a lower portion of the door to be positioned in a front side of the first hinge, and a connection member that is coupled to the first hinge at its one end portion and detachably coupled to the second hinge at the other end portion to connect the first hinge and the second hinge.

In this instance, the connection member may include a body that is coupled to a fastening hole formed on a front surface of the first hinge, and a head that extends from the body to face the front side of the first hinge and has a width different from that of the body.

Also, the body and the head may have shapes different from each other.

Also, a connection member through hole corresponding to the connection member may be formed on one surface of the second hinge facing the fastening hole so that the second hinge is detachably coupled to the connection member.

Also, the connection member through hole may include a fastening unit that has a shape corresponding to the head so that the head passes through the fastening unit toward a front side of the second hinge, and a locking unit that grips and fixes an outer surface of the body to prevent the connection member from being separated from the connection member through hole.

Also, the locking unit may have a shape corresponding to the body.

Also, when the second hinge is moved in a first direction in a state in which the head passes through the fastening unit, the head may protrude from a front side of the locking unit, and the body may be coupled to the locking unit.

Also, when the second hinge is moved in a second direction, the body may be separated from the locking unit, and the head may be positioned on a straight line with the fastening unit so that the second hinge can be separated from the connection member.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view showing an appearance of a refrigerator according to an embodiment of the present disclosure;

FIG. 2 is a cross-sectional view showing a refrigerator according to an embodiment of the present disclosure;

FIG. 3 is a perspective view showing a state in which a door of a refrigerator according to an embodiment of the present disclosure is opened;

FIG. 4 is a perspective view showing a coupling relationship between a door and a main body of a refrigerator according to an embodiment of the present disclosure;

FIG. 5 is an exploded perspective view showing a hinge bracket installed in a refrigerator according to an embodiment of the present disclosure;

FIG. 6 is a perspective view showing a state in which a fixing member of a hinge bracket installed in a refrigerator according to an embodiment of the present disclosure is separated;

FIG. 7 is a perspective view showing a state in which a second hinge of a hinge bracket installed in a refrigerator according to an embodiment of the present disclosure is uncoupled from a first hinge; and

FIG. 8 is a perspective view showing a state in which a second hinge of a hinge bracket installed in a refrigerator according to an embodiment of the present disclosure is separated from a first hinge.

### DETAILED DESCRIPTION

Reference will now be made in detail to the embodiments of the present disclosure, examples of which are illustrated in the accompanying drawings, wherein like reference numerals refer to like elements throughout.

Hereinafter, preferred embodiments of the present disclosure will be described in detail with reference to the accompanying drawings.

Meanwhile, the terms “front end,” “rear end,” “upper portion,” “lower portion,” “top,” “bottom,” and the like used in the following descriptions are defined on the basis of the drawings, and a shape and a position of each component are not limited by these terms.

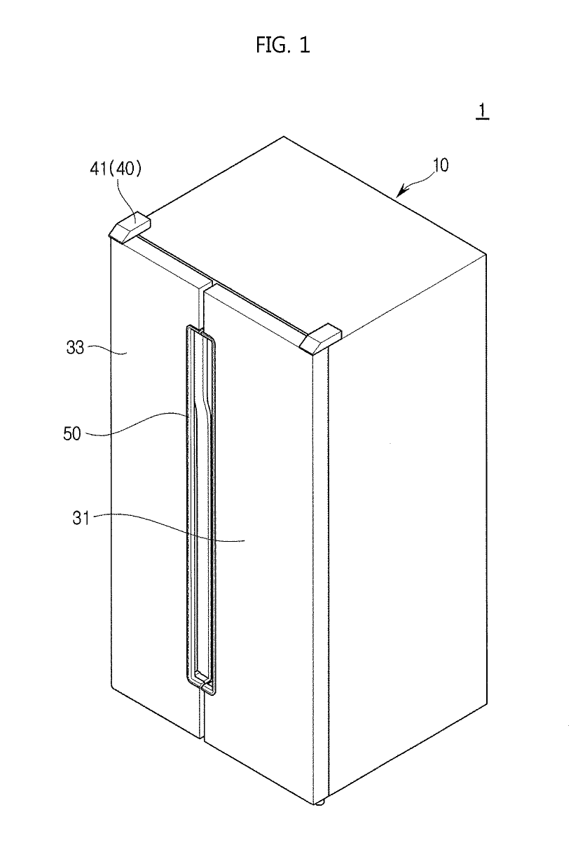

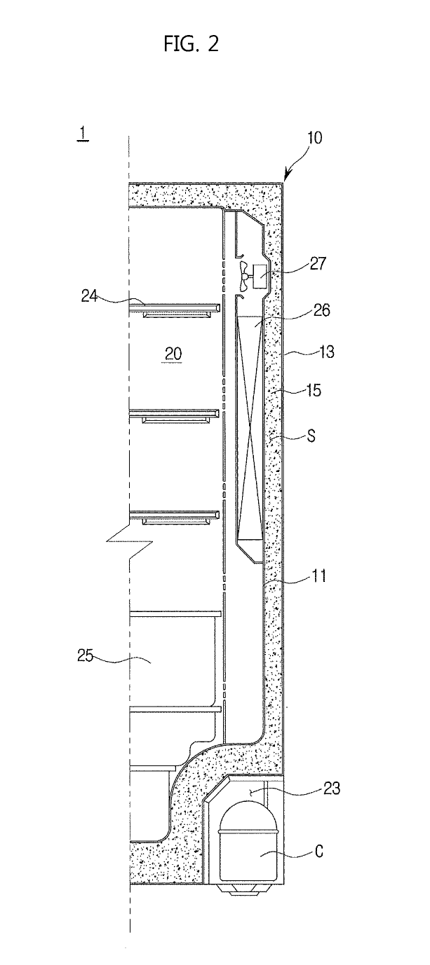

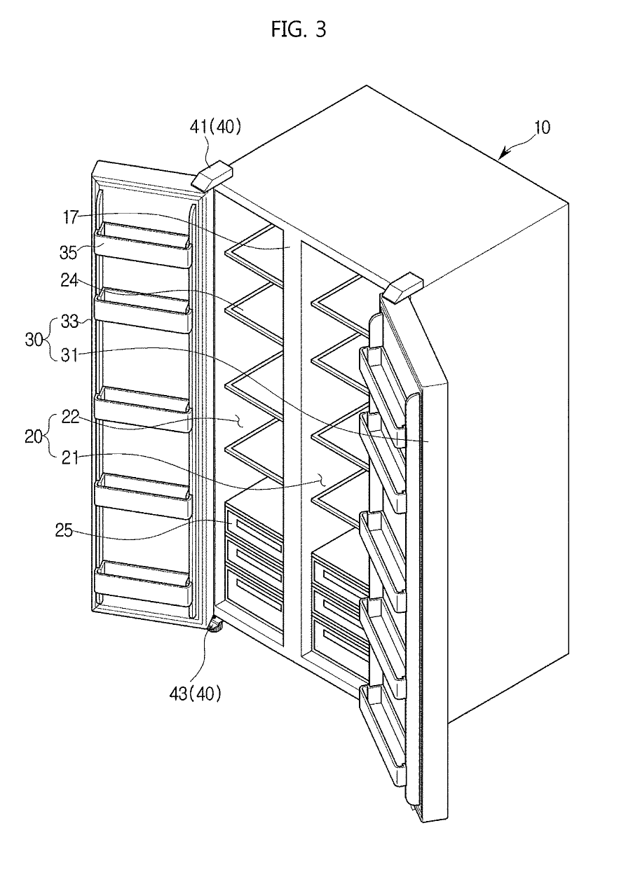

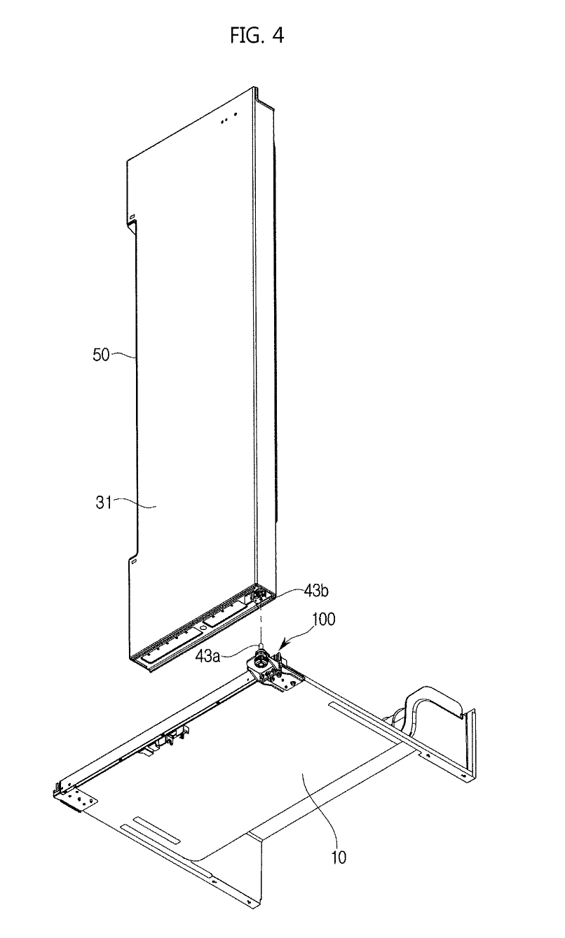

FIG. 1 is a perspective view showing an appearance of a refrigerator according to an embodiment of the present disclosure, FIG. 2 is a cross-sectional view showing a refrigerator according to an embodiment of the present disclosure, FIG. 3 is a perspective view showing a state in which a door of a refrigerator according to an embodiment of the present disclosure is opened, and FIG. 4 is a perspective view showing a coupling relationship between a door and a main body of a refrigerator according to an embodiment of the present disclosure.

As shown in FIGS. 1 to 4, a refrigerator 1 includes a main body 10 that forms an appearance of the refrigerator 1, a storage chamber 20 that is provided in such a manner that a front surface of the storage chamber 20 is opened inside the main body 10, a door 30 that opens and closes the storage chamber 20, and a hinge module 40 including an upper hinge 41 and a lower hinge 43 which allow the door 30 to be rotatably coupled to the main body 10.

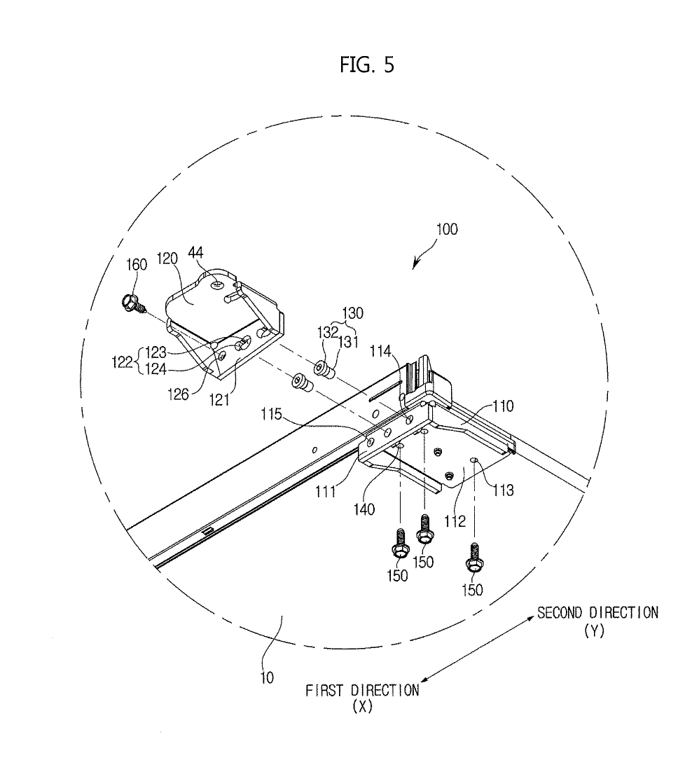

Specifically, the upper hinge 41 and the lower hinge 43 are fixed on both end portions of the top and bottom of the main body 10 so as to provide a central shaft for opening and closing the door 30. A hinge pin (not shown) of the upper hinge 41 is inserted into a pin insertion hole (not shown) formed in a top edge of the door 30 so as to act as a hinge axle at the time of opening and closing operation of the door 30. A hinge pin 43a of the lower hinge 43 is inserted into a pin insertion hole 43b formed in a bottom edge of the door 30 so as to act as a hinge axle at the time of opening and closing operation of the door 30 together with the hinge pin of the upper hinge 41. The hinge pin 43a of the lower hinge 43 passes through a pin coupling hole 44 (see FIG. 5) formed in a second hinge 120 (see FIG. 5) coupled to the bottom of the door 30, and coupled to the pin insertion hole 43b formed in the bottom edge of the door 30. Thus, a user can open and close the storage chamber 20 using a door handle 50 installed on a front surface of the door 30.

The main body 10 includes an inner box 11 that forms the storage chamber 20, an outer box 13 that forms the appearance, and a cold air supply device that supplies cold air to the storage chamber 20.

The cold air supply device is constituted of a compressor C, a condenser (not shown), an expansion valve (not shown), an evaporator 26, a blower fan 27, and the like, and a thermal insulating material 15 for preventing cold air in the storage chamber 20 from leaking out is foamed between the inner box 11 and the outer box 13 of the main body 10.

A machine room 23 in which the compressor C for compressing a refrigerant and the condenser for condensing the compressed refrigerant are installed is provided in a rear lower side of the main body 10.

The storage chamber 20 is partitioned to the right and left by a partitioning wall 17, a refrigerating chamber 21 is provided in the right side of the main body 10, and a freezing chamber 22 is provided in the left side of the main body 10.

The refrigerating chamber 21 and the freezing chamber 22 are opened and closed by a refrigerating chamber door 31 and a freezing chamber door 33 each being rotatably coupled to the main body 10, and a plurality of door guards 35 for storing foods and the like are provided on a rear surface of each of the refrigerating chamber door 31 and the freezing chamber door 33.

A plurality of shelves 24 are provided in the storage chamber 20 to partition the storage chamber 20 into a plurality of sections, and goods such as foods and the like are loaded on tops of the shelves 24.

In addition, a plurality of storage boxes 25 are provided so as to be drawn in and out of the storage chamber 20 in a sliding manner.

A foam space S is provided between the inner box 11 forming the storage chamber 20 and the outer box 13 coupled to the outer side of the inner box 11 to form the appearance, and filled with the thermal insulating material 15.

In order to enhance a thermal insulating characteristic of the thermal insulating material 15, a vacuum insulation panel (VIP, not shown) may be filled together with the thermal insulating material 15.

FIG. 5 is an exploded perspective view showing a hinge bracket installed in a refrigerator according to an embodiment of the present disclosure. A second fixing member 160 may be used as the same meaning as the fixing member. In addition, at least one of the upper hinge 41 and the lower hinge 43 may have a shape of a hinge bracket 100 according to an embodiment of the present disclosure. Specifically, there is a case in which the door 30 is required to be separated from the main body 10 in a process of moving or installing the refrigerator 1. In this instance, the upper hinge 41 and the lower hinge 43 are required to be separated, and particularly when the lower hinge 43 is separated, the main body 10 of the refrigerator 1 is required to be laid or a separate tool is required. In order to eliminate such inconvenience, the hinge bracket 100 according to an embodiment of the present disclosure may have a more desirable shape to the lower hinge 43. Thus, hereinafter, the hinge bracket 100 used in the lower hinge 43 will be mainly described.

As shown in FIG. 5, the hinge bracket 100 connecting the door 30 and the main body 10 may include a first hinge 110 and the second hinge 120.

The first hinge 110 is coupled to a bottom surface of the main body 10. At least one insertion hole 113 is formed on a bottom surface 112 of the first hinge 110 facing the bottom surface of the main body 10, and the first hinge 110 is fixed to the bottom surface of the main body 10 by at least one first fixing member 150 that passes through the at least one insertion hole 113. On a front surface 111 of the first hinge 110 facing the front side, at least one fastening hole 114 and at least one first fixing hole 115 may be formed, which will be described later.

The second hinge 120 may be coupled to a bottom surface of the door 30 and detachably coupled to the front side of the first hinge 110. At least one connection member 130 connecting the first hinge 110 and the second hinge 120 may be provided in the first hinge 110. The at least one connection member 130 is coupled to the at least one fastening hole 114 formed on the front surface of the first hinge 110 so as to correspond to the at least one connection member 130.

Specifically, the at least one connection member 130 may include a body 131 and a head 132. The body 131 is coupled to the at least one fastening hole 114 so as to face the rear side of the first hinge 110, and the head 132 extends from the body 131 so as to face the front side of the first hinge 110. The at least one connection member 130 is coupled to the at least one fastening hole 114 so that the head 132 protrudes toward the front side of the first hinge 110. The head 132 may protrude toward the outer side of the body 131 so as to have a diameter larger than a diameter of the body 131.

The at least one connection member 130 may be formed integrally with the first hinge 110 so that the head 132 protrudes toward the front side of the first hinge 110.

At least one stopper 140 may be provided in the first hinge 110. The at least one stopper 140 may be provided in the rear side of the at least one fastening hole 114 so as to support the at least one connection member 130 passing through the at least one fastening hole 114. The at least one stopper 140 may be coupled to a recessed portion (not shown) formed on the bottom surface 112 of the first hinge 110, and have a space protruding toward the lower side of the main body 10. The at least one stopper 140 may face one end of the body 131 of the at least one connection member 130 passing through the at least one fastening hole 114.

At least one connection member through hole 122 corresponding to the at least one connection member 130 may be formed on a rear surface 121 of the second hinge 120 facing the front surface 111 of the first hinge 110, so that the second hinge 120 can be detachably coupled to the at least one connection member 130.

The at least one connection member through hole 122 may include a fastening unit 123 and a locking unit 124.

The fastening unit 123 and the locking unit 124 may have diameters different from each other. Specifically, the fastening unit 123 may have a diameter larger than that of the head 132 so that the head 132 can be coupled or separated, and the locking unit 124 may have a diameter smaller than that of the head 132 so that the head 132 can be prevented from being separated from the at least one connection member through hole 122. The fastening unit 123 and the locking unit 124 may be connected to each other so that the at least one connection member 130 can be moved between the fastening unit 123 and the locking unit 124. When the body 131 is coupled to the locking unit 124, the at least one connection member 130 may be fixed to the at least one connection member through hole 122.

In addition, the fastening unit 123 and the locking unit 124 may have shapes different from each other. The fastening unit 123 may have a shape corresponding to the head 132 so that the head 132 passes through the fastening unit 123 to face the front side of the second hinge 120, and the locking unit 124 may have a shape corresponding to the body 131 so as to grip and fix the outer surface of the body 131. The fastening unit 123 may have a width larger than that of the locking unit 124 coupled to the body 131 so that the head 132 having a width larger than that of the body 131 can pass through the fastening unit 123.

On the rear surface 121 of the second hinge 120 facing the at least one fastening hole 114, at least one second fixing hole 126 corresponding to the at least one first fixing hole 115 provided on the front surface 111 of the first hinge 110 may be formed. The second hinge 120 may be coupled to the front surface 111 of the first hinge 110 by a second fixing member 160 passing through the at least one second fixing hole 126 and the at least one first fixing hole 115 toward the rear side of the first hinge 110 in order to compensate a coupling force between the first hinge 110 and the second hinge 120 by the at least one connection member 130.

The first fixing member 150 and the second fixing member 160 may include bolts.

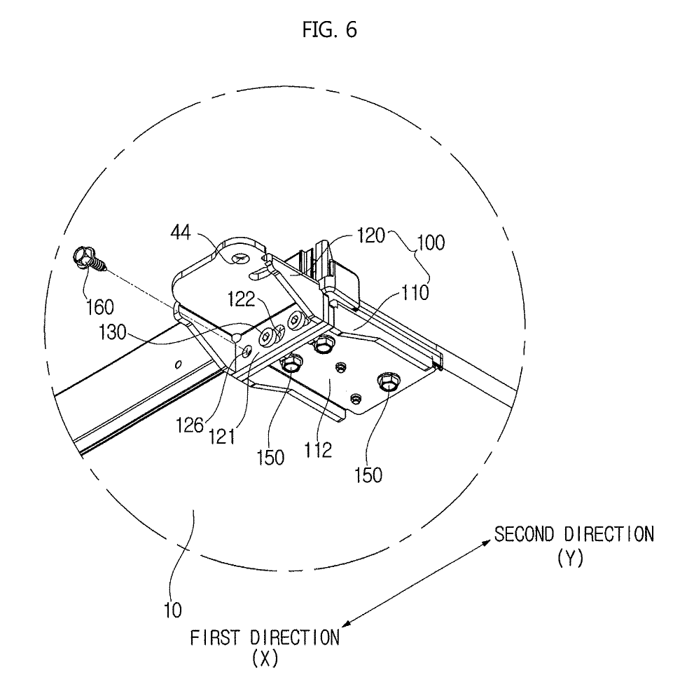

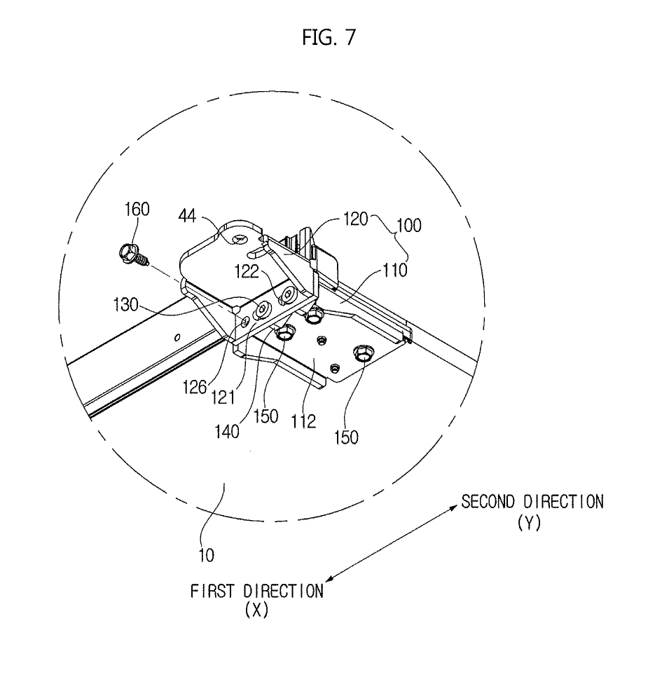

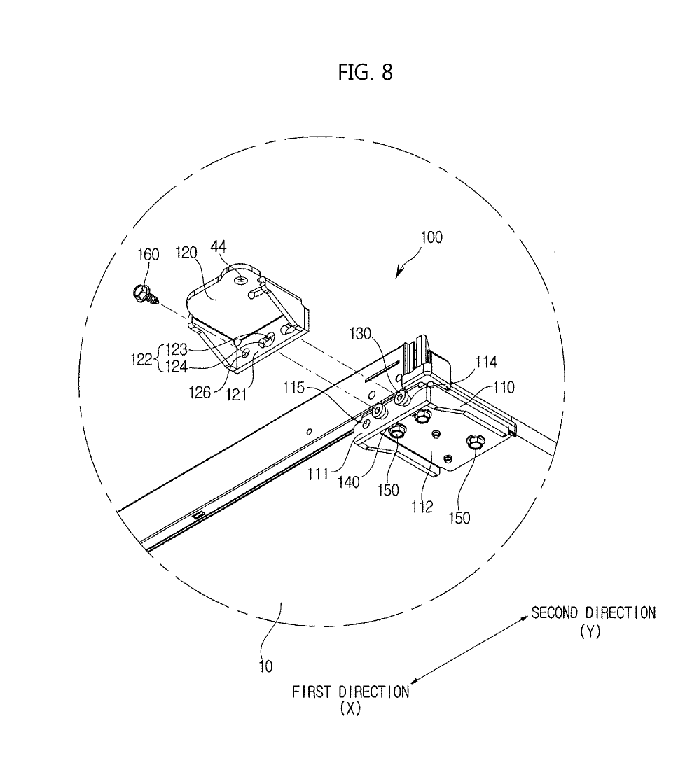

FIG. 6 is a perspective view showing a state in which a fixing member of a hinge bracket installed in a refrigerator according to an embodiment of the present disclosure is separated, FIG. 7 is a perspective view showing a state in which a second hinge of a hinge bracket installed in a refrigerator according to an embodiment of the present disclosure is uncoupled from a first hinge, and FIG. 8 is a perspective view showing a state in which a second hinge of a hinge bracket installed in a refrigerator according to an embodiment of the present disclosure is separated from a first hinge. Reference numerals which are not shown are referred to FIGS. 1 to 5.

As shown in FIGS. 6 to 8, a process of coupling the second hinge 120 to the first hinge 110 is as follows.

The second hinge 120 is disposed in the front side of the first hinge 110 so that the at least one connection member through hole 122 can face the at least one connection member 130. The second hinge 120 is allowed to approach the front surface 111 of the first hinge 110 so that the head 132 of the at least one connection member 130 can pass through the fastening unit 123 of the at least one connection member through hole 122. When the head 132 passes through the fastening unit 123, the second hinge 120 is slidably moved in a first direction (X). When the second hinge 120 is slidably moved in the first direction (X), the head 132 is positioned in the front side of the locking unit 124, and one end of the body 131 extending from the head 132 is coupled to the locking unit 124, and therefore the second hinge 120 may be coupled to the first hinge 110. In order to enhance the coupling force between the first hinge 110 and the second hinge 120, the second fixing member 160 sequentially passing through the second fixing hole 126 and the first fixing hole 115 is coupled to the second hinge 120 and the first hinge 110.

A process of separating the second hinge 120 from the first hinge 110 is as follows.

The second fixing member 160 sequentially passing through the second fixing hole 126 and the first fixing hole 115 toward the rear side of the first hinge 110 to thereby connect the first hinge 110 and the second hinge 120 is removed. When the second hinge 120 is slidably moved in a second direction (Y), the head 132 is positioned in the front side of the fastening unit 123, and the body 131 is spaced apart from the locking unit 124. In this case, the at least one connection member 130 is positioned on a straight line with the fastening unit 123. When the second hinge 120 is moved toward the front side of the second hinge 120, the second hinge 120 is separated from the first hinge 110 while the at least one connection member 130 is spaced apart from the at least one fastening hole 114.

The first direction (X) and the second direction (Y) may be opposite to each other.

As described above, according to the embodiments of the present disclosure, the hinge bracket provided in the lower portion of the refrigerator may be separated, and the first hinge coupled to the main body and the second hinge coupled to the door may be provided, and therefore the door and the main body can be easily separated from each other in a state in which the refrigerator is erected, thereby improving installation convenience of the refrigerator.

In order to couple the detachable first and second hinges, durability of the hinge bracket constituted of the first hinge and the second hinge may be improved, so that the first hinge and the second hinge provided in the lower portion of the refrigerator can withstand the load of the door and the main body using the at least one connection member provided in the first hinge and the at least one fixing member passing through the first hinge and the second hinge.

Although a few embodiments of the present disclosure have been shown and described, it would be appreciated by those skilled in the art that changes may be made in these embodiments without departing from the principles and spirit of the disclosure, the scope of which is defined in the claims and their equivalents.

What is claimed is:

1. A refrigerator comprising:
a main body that forms an appearance of the refrigerator;
a storage chamber that is provided inside the main body;
a door that is rotatably coupled to the main body to open and close an opened front surface of the storage chamber; and
a hinge bracket that connects the main body and the door,
wherein the hinge bracket includes:
a first hinge that is coupled to the main body; and
a second hinge that is coupled to the door and detachably coupled to a front side of the first hinge.

2. The refrigerator according to claim 1, wherein at least one fastening hole corresponding to at least one connection member for connecting the first hinge and the second hinge is formed on a front surface of the first hinge, so that the at least one connection member is coupled to the front surface of the first hinge.

3. The refrigerator according to claim 2, wherein the at least one connection member includes:
a body that is coupled to the at least one fastening hole to face a rear side of the first hinge; and
a head that extends from the body and protrudes from the at least one fastening hole to face a front side of the first hinge.

4. The refrigerator according to claim 3, wherein at least one connection member through hole corresponding to the at least one connection member is formed on one surface of the second hinge facing the at least one fastening hole, so that the second hinge is detachably coupled to the at least one connection member.

5. The refrigerator according to claim 4, wherein the second hinge is coupled to the at least one connection member so that the head passes through the at least one connection member through hole to face a front side of the second hinge.

6. The refrigerator according to claim 5, wherein the at least one connection member through hole includes:
a fastening unit through which the head passes toward the front side of the second hinge; and
a locking unit that is connected to the fastening unit to be coupled to the body to prevent the head from being separated from the at least one connection member through hole.

7. The refrigerator according to claim 6, wherein the fastening unit has a diameter larger than that of the head so that the head passes through the fastening unit, and
the locking unit has a diameter smaller than that of the fastening unit so that the locking unit is coupled to the body having a diameter smaller than that of the head.

8. The refrigerator according to claim 7, wherein, when the second hinge slides in a first direction in a state in which the head passes through the fastening unit, the head is positioned in a front side of the locking unit, and one end portion of the body extending from the head is coupled to the locking unit.

9. The refrigerator according to claim 8, wherein, when the second hinge slides in a second direction, the head is positioned in a front side of the fastening unit so that the second hinge can be separated from the at least one connection member.

10. The refrigerator according to claim 8, wherein a second fixing hole corresponding to a first fixing hole provided in the front side of the first hinge is formed on one surface of the second hinge facing the at least one fastening hole, and
the second hinge is coupled to the front side of the first hinge by a fixing member passing through the second fixing hole and the first fixing hole toward the rear side of the first hinge, to thereby compensate a coupling force between the first hinge and the second hinge.

11. The refrigerator according to claim 3, wherein the at least one connection member is formed integrally with the first hinge so that the head protrudes from the at least one fastening hole.

12. The refrigerator according to claim 3, wherein the first hinge includes at least one stopper that is provided in a rear side of the at least one fastening hole to support the at least one connection member passing through the at least one fastening hole.

13. A refrigerator comprising:
a main body that forms an appearance of the refrigerator;
a storage chamber that is provided inside the main body;
a door that is rotatably coupled to the main body to open and close an opened front surface of the storage chamber; and
a hinge bracket that connects the main body and the door,
wherein the hinge bracket includes:
a first hinge that is coupled to a lower portion of the main body;
a second hinge that is coupled to a lower portion of the door to be positioned in a front side of the first hinge; and
a connection member that is coupled to the first hinge at its one end portion and detachably coupled to the second hinge at the other end portion to connect the first hinge and the second hinge.

14. The refrigerator according to claim 13, wherein the connection member includes:
a body that is coupled to a fastening hole formed on a front surface of the first hinge; and
a head that extends from the body to face the front side of the first hinge and has a width different from that of the body.

15. The refrigerator according to claim 14, wherein the body and the head have shapes different from each other.

16. The refrigerator according to claim 15, wherein a connection member through hole corresponding to the connection member is formed on one surface of the second hinge facing the fastening hole so that the second hinge is detachably coupled to the connection member.

17. The refrigerator according to claim 16, wherein the connection member through hole includes:
a fastening unit that has a shape corresponding to the head so that the head passes through the fastening unit toward a front side of the second hinge; and
a locking unit that grips and fixes an outer surface of the body to prevent the connection member from being separated from the connection member through hole.

18. The refrigerator according to claim 17, wherein the locking unit has a shape corresponding to the body.

19. The refrigerator according to claim 18, wherein, when the second hinge is moved in a first direction in a state in which the head passes through the fastening unit, the head protrudes from a front side of the locking unit, and the body is coupled to the locking unit.

20. The refrigerator according to claim 19, wherein, when the second hinge is moved in a second direction, the body is separated from the locking unit, and the head is positioned on a straight line with the fastening unit so that the second hinge can be separated from the connection member.

21. A refrigerator having a main body and a door, the refrigerator comprising:
a hinge bracket comprising:
a first hinge that is coupled to a portion of the main body; and
a second hinge that is coupled to a portion of the door to be positioned in a front side of the first hinge
